(19) United States
(12) Patent Application Publication
(10) Pub. No.: US 2003/0063223 A1
(43) Pub. Date: Apr. 3, 2003

(54) Detecting static areas

(76) Inventors: Olukayode Anthony Ojo, Eindhoven (NL); Herman Schoemaker, Eindhoven (NL); Perry Gerard Mevissen, Eindhoven (NL)

Correspondence Address: U.S. Philips Corporation, 580 White Plains Road, Tarrytown, NY, 10591, US

(21) Appl. No.: 10/261,842

(22) Filed: Sep. 30, 2002

(30) Foreign Application Priority Data
Oct. 3, 2001 (EP) 01203733.9

(51) Int. Cl. H04N 9/64; H04N 5/14

(52) U.S. Cl. 348/700

(57) ABSTRACT

The invention provides detecting a static area in video images wherein frame difference information (6) and displaced frame difference information (4) are calculated, and the static area is detected using the frame difference information (6) and the displaced frame difference information (4) in combination.

The present invention relates to detecting static areas in video images.

In compressed video schemes such as MPEG2, detection of static areas is important. The reason being that if a block of pixels in one picture frame can be identified as remaining unchanged with respect to the previous frame the information required to be sent to the receiver may be substantially reduced. Effectively because the transmission of information about a block of pixels being unchanged requires substantially less bandwidth than transmitting the entire information content of these pixels over and over again in one or more successive frames.

Another reason for detecting static areas is to allow the use of an alternative de-interlacing or field-rate up-conversion in case there is no motion. De-interlacing is achieved by merging two fields, whereas field-rate up-conversion is achieved by repetition of a given frame.

A simple method of detecting static areas is to subtract subsequent images from each other. The difference called frame difference FD is an indicator of motion. Ideally if an area is static or stationary, the FD should be zero. However, in practice the static areas will always contain one kind of noise. In order to compensate for such noise any FD below a certain predetermined threshold can be interpreted as indicating a static area. The predetermined threshold being adjustable in accordance with the expected or estimated noise level in the image. An example of such a method for detection of static areas is known from EP-A-951 181.

However, in practice the situation where a an image is absolutely stationary is rare in video, as there will often be motion within an image or there will sequences be an overall displacement or motion of the image. Accordingly, in those situations the FD will not yield a useful result.

To take into account the latter of the above situations, motion compensated systems are used. In motion compensated systems, i.e. systems taking into account regions of the picture, which are as such unchanged but move relatively to the picture from one frame to the next, e.g. a camera panning over an otherwise unchanged background, the detection of static areas is still quite a challenge. In such systems a motion vector, indicating the relative motion or displacement of an otherwise unchanged block in relation to the overall picture, is estimated by a motion estimator. This motion vector is used to predict the position of respective blocks in subsequent frames, based on their position in a current frame.

In such motion compensated video processing system one way of detecting static areas is to observe the motion activity. The motion activity is the sum of all motion vectors within each region of the video picture. Ideally this sum should be zero if no motion occurs.

However, practical motion estimators do not always produce zero motion vectors on stationary video sequences.

There are several reasons for this. One, noise in the image may be interpreted as motion. Two, time-varying image processing prior to then motion estimation can lead to fluctuating intensity values. Three, detail in the picture combined with inherent flicker can lead to non-zero motion vectors, even though the image itself is stationary. Four, the motion estimator has limited accuracy because it needs to converge temporally, spatially or both. Especially in periodic structures, motion vectors can be found that matches the selection criterion, but are not actually useful for the image interpolation. Five, if the video input is interlaced, the field to field line position variation can be interpreted as vertical displacement, thus giving a false motion vector. Six, the subcarrier frequency in a composite signal generates a periodic moving pattern in the picture, which may also be interpreted as motion. Accordingly, also in this case the sum is compared to a given threshold, which may be adjustable. If the sum falls below the threshold the region is identified as static.

As mentioned, the motion vectors in motion compensated systems indicate estimated displacement of blocks between two successive picture frames. These vectors are used to calculate a displaced frame. In such systems the displaced frame difference DFD, that is to say the difference between the actual frame and the displaced frame calculated from the previous frame using the motion vectors, can be used to indicate static areas. Thus, the DFD is similar to the FD described above, except the pictures are motion compensated before the difference is calculated.

If however the image is in fact static, the motion estimator, which is used to estimate the displacement—which is not there—will make the detection of static areas less precise, because of the above reasons.

It is an object of the invention to provide improved detection of static areas. To this end, the invention provides a method and device for detecting static areas and a video processing apparatus.

Advantageous embodiments are defined in the dependent claims.

According to the first aspect of the invention, frame difference information and displaced frame difference information are calculated, and static areas are detected using the frame difference information and the displaced frame difference information in combination.

This aspect is advantageously applied in a video processing apparatus in particular in an apparatus which includes circuitry for performing motion compensation, because such circuitry usually already includes means for calculating displaced frame differences.

In a preferred embodiment of the invention the area is detected as static if the frame difference is below a given threshold or if the displaced frame difference is below a given percentage of the frame difference.

In this manner the static area is reliably detected even when the motion estimator produces errors. This again makes it possible to switch off the motion vector or modify the signal processing for that area.

In a particularly preferred embodiment the area is a full image.

The invention will be understood in greater detail based on the following exemplary embodiment and the drawing. In the drawing

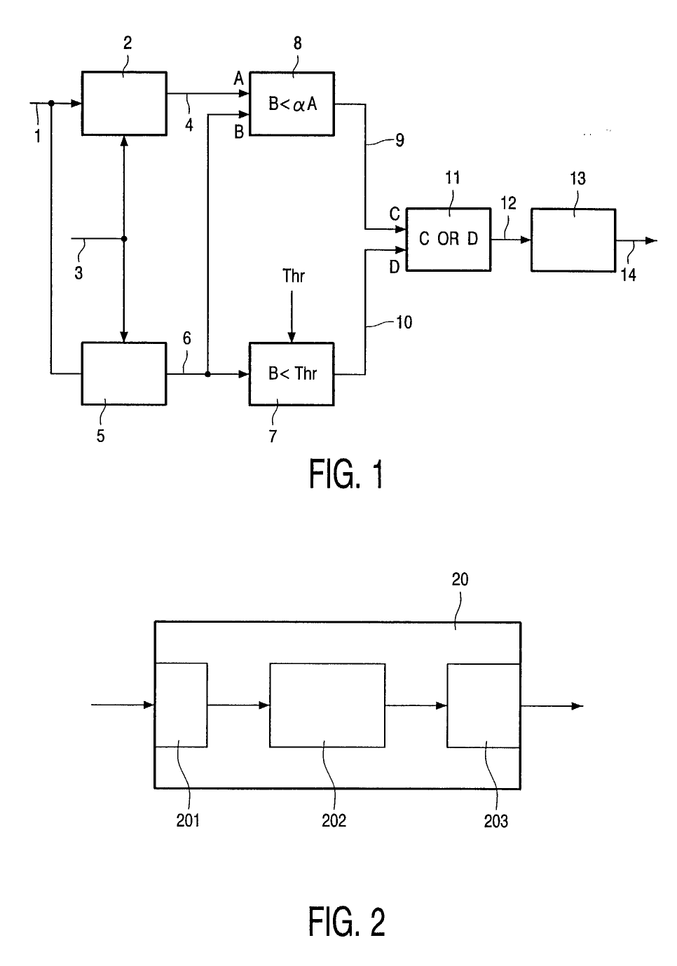

FIG. 1 shows a block diagram of a device for carrying out an improved still detection according to an embodiment of the invention;

FIG. 2 shows a video processing apparatus according to an embodiment of the invention.

In FIG. 1 a new input signal 1 representing a video image is introduced at the left hand side of the diagram. The input 1 is fed both to a motion estimator 2 and to subtractor 5. Further, a delayed signal 3, representing a previous image is fed to both the subtractor 5 and the motion estimator 2. In the subtractor 5 the frame difference DF is estimated based on accumulated differences or match errors between corresponding blocks in subsequent images. The subtractor outputs a DF signal 6 representing the displaced frame difference.

As mentioned, the input signal 1 and the delayed signal 3 are also fed to a motion estimator 2. In the motion estimator 2 the match errors between blocks, which, based on the estimated best motion vectors are assumed to correspond from one image to another, are determined. The motion estimator outputs a DFD signal 4 representing the displaced frame difference.

The FD signal 6 is fed to a first decision unit 7. The first decision unit the compares the FD signal with a threshold value Thr, and outputs a first decision signal 10. If the frame difference is smaller the threshold value, i.e. if the B<Thr, the first decision signal 10 represents logical true. If the frame difference is greater than or equal to the threshold value, i.e. if B≧Thr, the first decision signal represents logical false.

In a preferred embodiment the threshold value Thr is programmable, thereby allowing the threshold Thr to be adjusted to the level of noise or detail in the image.

The FD signal 6 and the DFD signal 4 are fed to respective inputs A and B of a second decision unit 8. The second decision unit 8 compares the FD signal and the DFD signal, and outputs a decision signal 9 depending on whether B is smaller than a given fraction α of A. The output decision signal 9 represents logically true if B<αA and logically false if B≧αA. The fraction α is preferably programmable so as to take into account varying image characteristics.

The first and second decision signals 9 and 10 are fed to respective inputs C and D of a third decision unit 11. The third decision unit outputs a third decision signal 12. In the preferred embodiment the third decision unit 11 constitutes a logical OR gate. Thus, the output of the third decision unit 11 represents logical true if either the first decision signal 10 or the second decision signal 9 represents logical true.

This third decision signal 12 may be used directly as an indicator for static areas, e.g. by setting a still flag representing logical true.

Since the input signal 1 is a sequence of images the decision signal 12 will be a sequence of true or false still flags indicating that the image is static or moving.

In the preferred embodiment the third decision signal 12 is filtered through a decision filter 13 in order to improve the robustness of the decision, by removing occasional errors. In particular a N-point median filter where N is 3 or more is used, but alternative filters may of cause be used for this post filtering The decision filter 13 yields a decision signal 14, e.g. in the form of a still flag.

FIG. 2 shows a video processing apparatus 20 comprising an input unit 201 coupled to a device 202 for detecting static areas in video images which is coupled to an output unit 203. The input unit 201 is arranged to receive an input signal which signal includes video images. The video images are furnished to the device 202. The device 202 is similar or identical to the device shown in FIG. 1. The device 202 processes the video images, the processing including detection of static areas. The static areas are suitably processed in the device 202. The result of the processing in device 202 is furnished to the output unit 203 which outputs the processed video images in a suitable form. The output unit 203 may be a transmission unit, but also a reproduction unit such as a display.

The video processing apparatus 20 may be a television apparatus.

Though the description refers to still detection in an image it will be apparent for the skilled person that various embodiments may be realized within the scope of the claims. In particular it will be apparent that the invention may not only be applied on a full image, but also on a part of an image only.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method for detecting a static area in video images wherein frame difference information (6) and displaced frame difference information (4) are calculated, and the static area is detected using the frame difference information (6) and the displaced frame difference information (4) in combination.

2. A method according to claim 1, wherein the area is detected as static if the frame difference (6) is below a given threshold (Thr) or if the displaced frame difference (6) is below a given percentage (a) of the frame difference (4).

3. A method according to claim 1, wherein the area is a full image.

4. A method according to claim 2, wherein the percentage (α) is programmable.

5. A method according to claim 4, wherein the programmable percentage (α) is adjustable to varying image characteristics.

6. A method according to claim 2, wherein the threshold (Thr) is programmable.

7. A method according to claim 6, wherein the programmable threshold (Thr) is adjustable in dependence of varying image characteristics.

8. Method according to claim 1, wherein based on the detection an output signal is generated.

9. Method according to claim 8, wherein the output signal is filtered.

10. A method according to claim 9, wherein the output signal is filtered using a median filter.

11. A device for detecting a static area in video images, the device comprising:
means for calculating frame difference information and displaced frame difference information, and
means for detecting the static area using the frame difference information and the displaced frame difference information in combination.

12. A video processing apparatus comprising:
an input unit for obtaining video images
a device as claimed in claim 11 for detecting static areas in the video images, the device being further arranged to process the video images in dependence on the detected static areas; and
an output unit for outputting the processed video images.
